(19) United States
(12) Patent Application Publication
(10) Pub. No.: US 2011/0070418 A1
(43) Pub. Date: Mar. 24, 2011

(54) POLYOLEFINIC HEAT-SHRINKABLE FILM

(75) Inventors: Thea A. Ellingson, Northfield, MN (US); Edward M. Chan, Loveland, OH (US)

(73) Assignee: BERRY PLASTICS CORPORATION, Evansville, IN (US)

(21) Appl. No.: 12/886,108

(22) Filed: Sep. 20, 2010

Related U.S. Application Data
(60) Provisional application No. 61/244,366, filed on Sep. 21, 2009.

(51) Int. Cl. B32B 7/02; B32B 27/32; B32B 5/00

(52) U.S. Cl. 428/218; 428/220; 428/523

(57) ABSTRACT

A multi-layer polyolefinic film for the unitization of goods is described. The multi-layer film has a multi-layer structure comprising various polyolefinic compositions, the polyolefinic layers having microcrystalline orientation providing the multi-layer film the ability to shrink in response to heat. The heat shrinkable multi-layer film may be placed over a good or a collection of loosely assembled goods and subjected to heat so that the film shrinks causing the good to be contained by the multi-layer film. The multi-layer film has sufficient clarity so that the good or goods can be visually seen through the film. The heat shrinkable polyolefinic multi-layer films are useful for applications where the loosely assembled goods require containment, but where it is also beneficial for the identity of the goods to not be obscured.

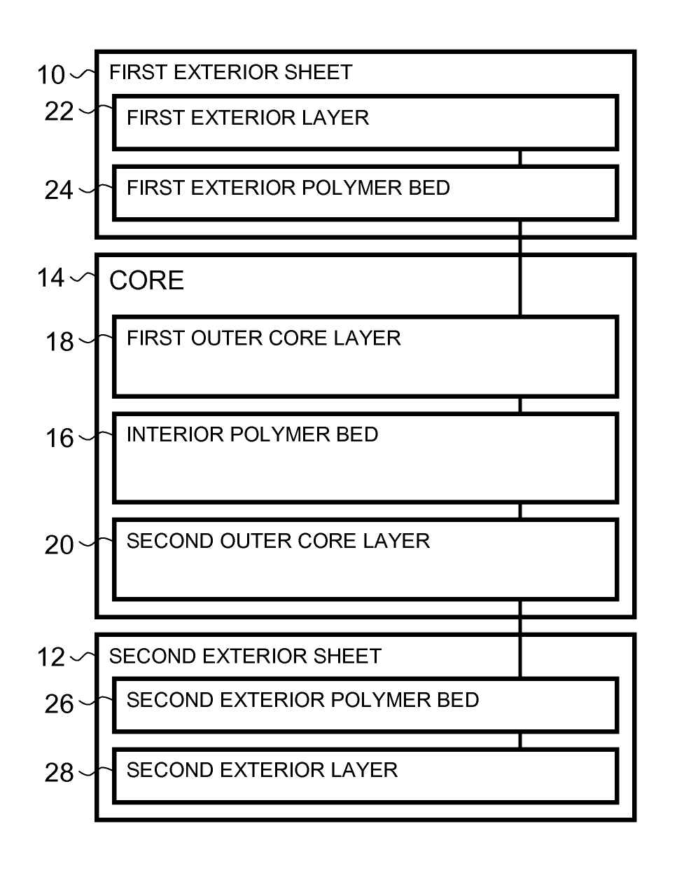

### PRIORITY CLAIM

This application claims priority under 35 U.S.C. §119(e) to U.S. Provisional Application Ser. No. 61/244,366, filed Sep. 21, 2009, which is expressly incorporated by reference herein.

### BACKGROUND

The present disclosure relates to a multi-layer film and a polymeric composition for heat-shrink packaging applications, and to a method of making the same. More particularly, the present disclosure relates to light-gauge multi-layer polyolefinic shrink films useful for unitizing loosely assembled goods, the method of manufacturing the multi-layer polyolefinic shrink films, and the use of the multi-layer polyolefinic shrink films in packaging.

Heat-shrinkable films are polymeric films that shrink mono-axially or bi-axially upon the application of heat. Films of this type are used in unitizing goods for more efficient commercial distribution. Heat-shrinkable films have been manufactured as mono-layer and three-layer films consisting of highly branched polyethylene homopolymers produced through a high-pressure tubular or autoclave free-radical polymerization, copolymers of ethylene and an alpha-olefin having three to ten carbon atoms, and/or mixtures thereof.

### SUMMARY

According to the present disclosure, a multi-layer shrink film is described which includes at least three layers. The film has properties that make it useful for shrink packaging.

In illustrative embodiments, a multi-layer shrink film comprises a diversely-branched polyethylene in at least one layer. In one embodiment, the multi-layer film comprises at least one layer comprising a substantially short-chain branching linear polyethylene. In another embodiment, the multi-layer film comprises at least one layer comprising an amorphous low density polyethylene. In another embodiment, the multi-layer film comprises at least one layer comprising a high density polyethylene having substantially no short-chain or long-chain branching. In another embodiment, the multi-layer film comprises at least one layer comprising a linear low-density polyethylene, a low-density polyethylene, or blends thereof. In illustrative embodiments, the composition and structure is such that the film exhibits a multi-layer heat-shrinkable polyolefinic film having a gauge normalized secant modulus (1% strain) of at least about 60000 psi in the MD. Illustrative embodiments exhibit improved shrink tension, load retention, puncture resistance, tear resistance, tensile strength, clarity, and/or specular reflectivity.

### BRIEF DESCRIPTION OF THE DRAWINGS

The detailed description particularly refers to the accompanying FIGURE in which:

Illustrated, is a diagrammatic view of a multi-layer shrink film in accordance with the present disclosure showing that in an illustrative embodiment the shrink film comprises, in series, a first exterior sheet including a first exterior layer and a first exterior polymer bed, a core including a first outer core layer, an interior polymer bed, and a second outer core layer, and a second exterior sheet including a second exterior polymer bed and a second exterior layer.

### DETAILED DESCRIPTION

The present disclosure describes multi-layer shrink films comprised of a first exterior sheet 10, a second exterior sheet 12, and a core 14 interposed between the first exterior sheet 10 and a second exterior sheet 12.

In illustrative embodiments, the first exterior sheet 10 is comprised of a first exterior layer 22 and a first exterior polymer bed 24 interposed between and arranged to contact the first exterior layer 22 and the core 14, the second exterior sheet 12 is comprised of a second exterior layer 28 and a second exterior polymer bed 26 interposed between and arranged to contact the second exterior sheet 12 and the core 14, and the core 14 is comprised of an interior polymer bed 16 interposed between and arranged to contact a first outer core layer 18 and a second outer core layer 20.

In illustrative embodiments, a shrink film is produced by co-extruding two or more polymeric resins or blends of polymeric resins through an annular die in a manner and with an applied pressure such that the resins are co-extruded and blown into a cylindrical film in which the at least one of the polymeric resins attains a strained microcrystalline orientation which is locked into the film during cooling. The microcrystalline orientation is entropically unfavorable; subsequent heating of the film permits relaxation of the internal stresses and adaptation of a more entropically favorable state. The entropically favorable state is dimensionally smaller along the plane of the film. Thus, the film shrinks when it is heated.

One aspect of the present disclosure is that using a diversely-branched polyethylene resin with both short-chain and long-chain branching unexpectedly leads to enhanced shrink film properties. Low-density free-radical polymerized polyethylene (LDPE) and linear low-density catalyzed polyethylene (LLDPE) have been combined in multi-layer and monolayer configurations to make shrink films (i.e., European Published Patent Application EP-0404368). However, the present disclosure describes a multi-layer structure which combines a diversely-branched polyethylene having both short-chain and long-chain branching with conventional polymers in a co-extruded structure to provide enhanced performance.

One attribute of high-pressure free-radical polymerized polyethylene (e.g. LDPE) is that it has substantial long-chain branching; for example, branching may exist between 0.02% up to about 2% of the carbon atoms. One attribute of metallocene catalyzed polyethylene (e.g. mLLDPE) is that it includes substantially no long-chain branching, but instead includes short-chain branching. Blending these resins together provides levels of performance which are attributable to the benefits of both the short and long-chain branching on the microcrystalline orientation. However, blending the two polymers together will not result in the properties disclosed herein. Unexpectedly, a polyethylene having both short-chain branching and long-chain branching within a single polymeric molecule results in properties which substantially exceed those properties that could be obtained from merely blending polymers having either short-chain or long-chain branching.

Another aspect of the present disclosure is that the combination of multiple layers, as described herein, provides a synergistic relationship not achievable by blending the components from each layer into a mono-layer film. In particular, the microcrystalline orientation of the various layers may be distinct after manufacture, a characteristic that a homogeneous mono-layer film would not readily exhibit. According to another aspect of the present disclosure, it was discovered that diversely branched resins containing both short- and long-chain branching, because of their unique and beneficial properties, can be used in relatively small quantities to enhance the overall performance of a film. For example, a film having between about 10% and about 30% by weight of a diversely branched polyethylene may exhibit substantial advantages over the corresponding monolayer blend of the same components. Accordingly, products with unexpected properties can be produced at an enhanced efficiency. Another aspect of the present disclosure is the specific structures defined herein, including both the order and the proportion of the layers, contribute to the performance characteristics observed. Particularly, in was determined that the placement and concentration of polyethylene having both short and long-chain branching can contribute to the beneficial film properties observed.

Another aspect of the present disclosure is that the shrink film described herein may be manufactured entirely of polyethylene resins to the exclusion of other resins such as elastomers, polypropylene, and other non-polyethylene resins. Accordingly, one aspect of the present disclosure is that it is generally recyclable as a polyethylene material. Illustratively, the film comprises between about 80% to 100% polyethylene. In another embodiment, the film comprises about 90% to 100% polyethylene.

In illustrative embodiments, a multi-layer shrink film comprises a substantially long-chain branched polyethylene, a diversely branched polyethylene (a polyethylene having substantial short and long-chain branching), and a substantially short-chain branched polyethylene. In one embodiment, the multi-layer shrink film comprises at least seven layers. The extent to which a polymer is branched and the length of those branches may be determined by, for example, C-13 NMR, GPC, temperature rising elution fractionation (TREF), and Crystallization analysis fractionation (Crystaf). Furthermore, rheological properties may be used to compare relative amounts of short and long-chain branching. For example, relaxation time reflects the time taken for the polymer chains to relax after deformation in a molten condition.

In one embodiment, the high density polyethylene layer is interposed between and contacting two substantially equivalent polyethylene layers, both having substantial short and long-chain branching. In another embodiment, two layers comprising substantially short-chain branched polyethylene are arranged to form the exterior of the multi-layer film. In another embodiment, the polyethylene having substantial short and long-chain branching layer is substantially free of short-chain branched polyethylene. In yet another embodiment, the high density polyethylene has a bimodal molecular weight distribution (MWD).

In illustrative embodiments, the multi-layer shrink film includes at least one layer comprised of a diversely branched polyethylene. As used herein, the term diversely branched polyethylene means that on a given polymeric molecule, both long-chain branching and short-chain branching are present. In one embodiment, the diversely branched polyethylene includes at least some short-chain branching and at least some long-chain branching. Short-chain branching (SCB), as used herein, is branching of less than approximately 40 carbon atoms.

One aspect of the present disclosure is the SCB may interfere with the formation of the microcrystalline structures. As used herein, long-chain branching (LCB) is branching with lengths longer than the average critical entanglement distance of a linear polymer chain. For example, long-chain branching includes branching with chain lengths greater than 40 carbon atoms.

As used herein, substantially no long-chain branching is defined as a LCB density of less than about 0.01 long-chain branch points per 1000 main chain carbons. As used herein, some long-chain branching is defined as a LCB density of about 0.01 to about 0.2 long-chain branch points per 1000 main chain carbons. As used herein, substantial long-chain branching is used to describe polymers having greater than 0.2 long-chain branch points per 1000 main chain carbons.

As used herein, melt index (MI) refers to values as determined according to ASTM D 1238-00, and densities refer to values as determined according to ASTM D 1505-98.

In illustrative embodiments, the multi-layer shrink film includes at least one layer comprised of a diversely branched polyethylene having a MI of 0.25 to 1.0 g/10 min and a density of 0.915 to 0.940 g/cm³. In one embodiment, the diversely branched polyethylene has a MI of about 0.5 to about 0.8 g/10 min. In another embodiment, the diversely branched polyethylene has a MI of about 0.65 g/10 min. In one embodiment, the diversely branched polyethylene has a density of about 0.920 to about 0.930 g/cm³. In another embodiment, the diversely branched polyethylene has a density of about 0.925 g/cm³.

In one embodiment, the first exterior polymer bed 24 is comprised of a diversely branched polyethylene. In another embodiment, the multi-layer shrink film includes at least two layers comprised of a diversely branched polyethylene. In yet another embodiment, the second exterior polymer bed 26 is comprised of diversely branched polyethylene. In another embodiment, the first exterior polymer bed 24 and the second exterior polymer bed 26 are comprised of diversely branched polyethylene. In another embodiment, the diversely branched polyethylene of the first exterior polymer bed 24 and the diversely branched polyethylene of the second exterior polymer bed 26 are substantially equivalent. In yet another embodiment, the diversely branched polyethylene of the first exterior polymer bed 24 and the diversely branched polyethylene of the second exterior polymer bed 26 are extruded from a common source.

One aspect of the present disclosure is that performance may be enhanced by using a multi-layer structure instead of using blends. Accordingly, in illustrative embodiments, the multi-layer film includes at least one layer including a diversely branched polyethylene and at least one layer devoid of a diversely branched polyethylene. In one embodiment, the multi-layer film includes at least one layer including a diversely branched polyethylene and at least one layer including a substantially branched polyethylene that is devoid of a diversely branched polyethylene. In another embodiment, the multi-layer film includes at least one layer having a diversely branched polyethylene, at least one layer having a substantially branched polyethylene that is devoid of a diversely branched polyethylene, and at least one layer that has substantially no long-chain branching. In yet another embodiment, the multi-layer film includes two layers consisting of a diversely branched polyethylene, two layers consisting of a substantially branched polyethylene devoid of a diversely branched polyethylene, and one layer consisting of polyethylene having substantially no branching.

In illustrative embodiments, the multi-layer shrink film includes at least one layer comprising a substantially linear polyethylene. As used herein, a substantially linear polyethylene is a copolymer of ethylene including about 1% to about 20% of an alpha olefin monomer by weight of a total weight. The substantially linear polyethylene may be manufactured by any method known in the art. For example, means for producing a substantially linear polyethylene includes reacting ethylene and an alpha olefin comonomer through Ziegler-Natta, Philips, metallocene, or other single site catalyzed reactions. Furthermore, exemplary means of manufacturing the substantially linear polyethylene include both solution phase or gas phase reactors. A specific example includes the copolymerization of ethylene and octene in solution phase. Another specific example includes the copolymerization of lower molecular weight alpha olefin monomers such as butene and hexene with ethylene in a gas phase reactor.

In one embodiment, the substantially linear polyethylene is a polymer made through non-metallocene or “post-metallocene” catalyzed reactions resulting in a copolymer of ethylene and an alpha olefin copolymer. In one embodiment, the substantially linear polyethylene includes copolymers made with various alpha olefin monomers including 1-butene, 3-methyl-1-butene, 3-methyl-1-pentene, 1-hexene, 4-methyl-1-pentene, 3-methyl-1-hexene, 1-octene or 1-decene. In another embodiment, the alpha olefin comonomer may be incorporated from about 1% to about 10% by weight of the total weight of the polymer. In one embodiment, the substantially linear polyethylene comprises about 2% to about 10% 1-octene by weight. One aspect of the present disclosure is that a substantially linear polyethylene includes substantial SCB but substantially no LCB. Accordingly, substantially linear polyethylene may be referred to as substantially short-chain branched polyethylene. In illustrative embodiments, the substantially linear polyethylene is a product of reacting the ethylene and the alpha olefin monomer by means that causes the alpha olefin monomer to react with the ethylene to form a substantially linear polymer chain without substantial long-chain branching. As used herein, without substantial long-chain branching is used to describe polymers having less than 0.01 long-chain branch points per 1000 main chain carbons.

In one embodiment, the first exterior layer 22 is comprised of substantially linear polyethylene. In another embodiment, the multi-layer shrink film includes at least two layers of substantially linear polyethylene. In yet another embodiment, the second exterior layer 28 is comprised of substantially linear polyethylene. In another embodiment, the first exterior layer 22 and the second exterior layer 28 are comprised of substantially linear polyethylene. In another embodiment, the substantially linear polyethylene of the first exterior layer 22 and the substantially linear polyethylene of the second exterior layer 28 are substantially equivalent. In yet another embodiment, the substantially linear polyethylene of the first exterior layer 22 and the substantially linear polyethylene of the second exterior layer 28 are extruded from a common source.

In one embodiment, the substantially linear polyethylene resin has an average molecular weight from about 20,000 to about 500,000, preferably from about 50,000 to about 200,000. The average molecular weight (MW) and molecular weight distribution (MWD) influences the properties of the polyolefin. Many analytical techniques are available for the determination of the MW and MWD. One such approach is described in ASTM D 4001-93 (2006) which refers to the standard test method for determination of weight-average molecular weight of polymers by light scattering. Gel permeation chromatography (GPC) can provide information on the MW as well as the MWD.

In illustrative embodiments, the substantially linear polyethylene includes copolymers incorporating substantial short-chain branching (e.g. chains containing fewer than 40 carbons atoms). Reference may be made to U.S. Pat. Nos. 3,645,992, 4,011,382, 4,205,021, 4,302,566, 6,184,170, 6,919,467, U.S. Publ. Nos. 2008/0039606 and 2008/0045663 for examples of resins which may be particularly useful herein.

In illustrative embodiments, means for copolymerizing an alpha olefin monomer and ethylene include those means which result in a substantially linear polyethylene resins having significant short-chain branching to the exclusion of significant long-chain branching. For example, exemplary processes may include polymerization temperatures substantially lower than those high-pressure polymerizations used to form highly branched polyethylene having substantial long-chain branching. In one embodiment, the substantially linear polyethylene exhibits a relatively narrow MWD. Molecular weight distribution (MWD) is defined as M_{w}/Mₙ where M_{w} is the weight average molecular weight (in g/mol) and Mₙ is the number average molecular weight (in g/mol) as determined by gel permeation chromatography or other means referred to herein. In one embodiment, the MWD is less than about 8. In another embodiment, the MWD is less than about 5. In yet another embodiment, the MWD is about 2 to about 4.

In illustrative embodiments, the multi-layer film includes at least one layer comprising substantially linear polyethylene having a first MI of 0.25 to 1.0 g/10 min and a first density of 0.915 to 0.940 g/cm³. In one embodiment, the substantially linear polyethylene has a MI of about 0.5 to about 0.8 g/10 min. In another embodiment, the substantially linear polyethylene has a MI of about 0.65 g/10 min. In one embodiment, the substantially linear polyethylene has a density of about 0.920 to about 0.930 g/cm³. In another embodiment, the substantially linear polyethylene has a density of about 0.925 g/cm³.

In illustrative embodiments, the multi-layer shrink film includes at least one layer comprised of a polyethylene exhibiting substantial short and long-chain branching. In one aspect of the present disclosure, polyethylene exhibiting substantial short and long-chain branching may not pack into the crystal structures well. Therefore, polyethylene exhibiting substantial short and long-chain branching may have a tendency to form amorphous structures. Accordingly, the intermolecular forces are weaker and the instantaneous-dipole induced-dipole attraction may be lower. Furthermore, polyethylene exhibiting substantial short and long-chain branching has a lower tensile strength than more crystalline polyethylene but comparably greater ductility. Polyethylene exhibiting substantial short and long-chain branching may be polymerized through free-radical processes which accounts for the high degree of branching.

In one embodiment, the polyethylene exhibiting substantial short and long-chain branching has a MI of about 0.3 to about 1.0 g/10 min. In one embodiment, the polyethylene exhibiting substantial short and long-chain branching has a MI of about 0.5 to about 0.8 g/10 min. In another embodiment, the polyethylene exhibiting substantial short and long-chain branching has a MI of about 0.65 g/10 min. In one embodiment, the polyethylene exhibiting substantial short and long-chain branching has a density of about 0.915 to about 0.930 g/cm³. In another embodiment, the polyethylene exhibiting substantial short and long-chain branching has a density of about 0.920 to about 0.925 g/cm³. In yet another embodiment, the polyethylene exhibiting substantial short and long-chain branching has a density of about 0.92 g/cm³.

In illustrative embodiments, first outer core layer 18 comprises polyethylene exhibiting substantial short and long-chain branching. In one embodiment, the second outer core layer 20 comprises a polyethylene exhibiting substantial short and long-chain branching. In another embodiment, first outer core layer 18 comprises a blend of polyethylene exhibiting substantial short and long-chain branching and a substantially linear polyethylene. In one embodiment, first outer core layer 18 comprises about 40% to 100% polyethylene having substantial short and long-chain branching and 0% to about 60% substantially linear polyethylene. In another embodiment, first outer core layer 18 comprises about 60% to 80% polyethylene having substantial short and long-chain branching and about 20% to about 40% substantially linear polyethylene. In another embodiment, the multi-layer shrink film includes at least two layers comprising a polyethylene exhibiting substantial short and long-chain branching. In another embodiment, the polyethylene exhibiting substantial short and long-chain branching of the first outer core layer 18 and the polyethylene exhibiting substantial short and long-chain branching of the second outer core layer 20 are substantially equivalent. In yet another embodiment, the polyethylene exhibiting substantial short and long-chain branching of the first outer core layer 18 and the polyethylene exhibiting substantial short and long-chain branching of the second outer core layer 20 are extruded from a common source.

In illustrative embodiments, the multi-layer shrink film includes at least one layer comprised of high density polyethylene. In one embodiment, the high density polyethylene is a bimodal polyethylene. In another embodiment, the high density polyethylene is a product of reacting ethylene by a means to form a product exhibiting very little short-chain or long-chain branching so that the polyethylene has a highly crystalline structure.

As used herein, bimodal polyethylene has a MWD exhibiting a bimodal distribution. The term bimodal distribution means that the MWD in a gel permeation chromatography (GPC) curve or a distribution plot generated by a comparable analytical technique exhibits two component polymers wherein one component polymer exists as a distinct peak, a hump, a shoulder, or a tail relative to the peak of the second component polymer. The plot of a bimodal distribution can be deconvoluted into two components, the first being a low molecular weight component and the other being a high molecular weight component. After deconvolution, the peak width at half maxima and the weight average molecular weight (M_{w}) of each component can be described separately. In one embodiment, the second polyethylene is a product of reacting ethylene by a means to form a bimodal polyethylene composition comprising a first MWD of polyethylene and a second MWD of polyethylene, wherein the first MWD of polyethylene has a first average M_{w} and the second MWD has a second average M_{w} and the second average M_{w} is greater than 10,000 g/mol larger than the first average M_{w}.

Accordingly, while the molecular weight of the second polyethylene may be characterized by an average M_{w}, the distribution is more appropriately characterized by a first component having a first average M_{w} and a second component having a second average M_{w}. In illustrative embodiments, the second polyethylene has a first population of polyethylene with an average M_{w} of about 10,000 to about 60,000 g/mol. In one embodiment, the second polyethylene has a first population of polyethylene with an average M_{w} of about 25,000 to about 45,000 g/mol. In another embodiment, the second polyethylene has a first population of polyethylene with an average M_{w} of about 35,000 g/mol.

In illustrative embodiments, the second polyethylene has a second population of polyethylene having an average M_{w} of about 100,000 to about 600,000 g/mol. In one embodiment, the second polyethylene has a second population of polyethylene having an average M_{w} of about 300,000 to about 500,000 g/mol. In another embodiment, the second polyethylene has a second population of polyethylene having an average M_{w} of 375,000 to about 450,000 g/mol.

In illustrative embodiments, the second polyethylene has a bimodal distribution that includes a first population of polyethylene having an average M_{w} of about 10,000 to about 60,000 g/mol and a second population of polyethylene having an average M_{w} of about 100,000 to about 600,000 g/mol. In one embodiment, the second polyethylene has a bimodal distribution that includes a first population of polyethylene having an average M_{w} of about 25,000 to about 45,000 g/mol and a second population of polyethylene having an average M_{w} of about 300,000 to about 500,000 g/mol. In another embodiment, the second polyethylene has a bimodal distribution that includes a first population of polyethylene having an average M_{w} of about 35,000 g/mol and a second population of polyethylene having an average M_{w} of about 450,000 g/mol. While the MWD is bimodal, the density and MI either of the two populations and/or the composition as a whole may fall within those ranges described herein as a characteristic of the second polyethylene. Reference may be made to U.S. Pat. No. 6,787,608 for examples of resins which may be particularly useful herein.

In one embodiment, the bi-modal polyethylene has a MI of about 0.17 to about 0.6 g/10 min. In another embodiment, the bimodal polyethylene has a density of about 0.945 to about 0.954 g/cm³. In another embodiment the bi-modal polyethylene has a density of about 0.950 g/cm³.

While not being limited to any particular theory, the bimodal MWD of polyethylene stabilizes the film during the manufacturing process and allows thinner films to be reproducibly and controllably produced. Furthermore, the stabilization during manufacturing provides a manufactured film with properties beneficial to heat shrink applications, particularly, an increase in shrink tension.

In illustrative embodiments, the high density polyethylene is a co-polymeric high density polyethylene. In one embodiment, the co-polymeric high density polyethylene is a product of reacting ethylene and an alpha-olefin comonomer. In one embodiment, the co-polymeric high density polyethylene has a MI of about 0.25 to about 0.9 g/10 min and a density of about 0.935 to about 0.96 g/cm³.

In illustrative embodiments, the high density polyethylene is a homo-polymeric high density polyethylene with a mono-modal MWD. The homo-polymeric high density polyethylene is a product of reacting ethylene such that the product has substantially no branching. In one embodiment, the homo-polymeric high density polyethylene has a MI of about 1 to about 6 g/10 min and a density of about 0.935 to about 0.96 g/cm³.

In illustrative embodiments, the multi-layer shrink film is combined in a manner such that it exhibits shrinkage at temperatures of about 120-130° C. The rate of shrinkage is dependent upon the film properties and the temperature. In one embodiment, the multi-layer shrink film exhibits bi-axial shrinking (i.e. the film shrinks along the machine direction (MD) axis and the transverse direction (TD) axis). In one embodiment, the multi-layer shrink film has a thickness of about 3 mil and exhibits shrinkage of about 60% to about 70% in the MD and about 5% to about 20% in the TD when subjected to a temperature of about 140° C. for 30 seconds, as determined according to ASTM D2732-96. In another embodiment, a film having a thickness of about 1 mil exhibits shrinkage of about 80% to about 90% in the MD and about 10% to about 25% in the TD when subjected to a temperature of about 140° C. for 10 seconds. In another embodiment, the multi-layer heat-shrinkable polyolefinic film has a MD shrink of at least 75% and a TD shrink of at least 15%.

The thermal shrinkage of polyolefinic film may be determined according to ASTM D 2732-96. This is a standard test method for unrestrained linear thermal shrinkage. Unrestrained linear thermal shrinkage, otherwise known as free shrink, refers to the irreversible and rapid reduction in linear dimension in a specified direction occurring in film subjected to elevated temperatures under conditions where nil or negligible restraint to inhibit shrinkage is present. As used herein, shrinkage will be expressed as a percentage of the original dimension.

One aspect of the present disclosure is that the multi-layer shrink film is a light-gauge film. In illustrative embodiments, the film of the present disclosure is about 0.5 mil to about 7.0 mil in thickness. In another embodiment, the film is about 0.7 mil to about 4.0 mil in thickness. In another embodiment, the film is from about 0.9 mil to about 3.0 mil in thickness. As used herein, the unit mil is used as a thickness equal to one thousandth (10⁻³) of an inch which is approximately equal to 0.0254 millimeters. One aspect of the present disclosure is that the polymeric composition disclosed herein enables the stable manufacture of high performance heat shrinkable films which are thinner than those previously known in the art. The process of making a thinner film is known as down gauging.

In illustrative embodiments, the first exterior sheet 10 comprises about 10% to about 40% of the total film thickness. In one embodiment, the first exterior sheet 10 comprises about 20% to about 30% of the total film thickness. In another embodiment, the first exterior sheet 10 comprises about 25% of the total film thickness. In one embodiment, the second exterior sheet 12 comprises about 10% to about 40% of the total film thickness. In another embodiment, the second exterior sheet 12 comprises about 20% to about 30% of the total film thickness. In yet another embodiment, the second exterior sheet 12 comprises about 25% of the total film thickness. In one embodiment, the core 14 comprises about 20% to about 80% of the total film thickness. In another embodiment, the core 14 comprises about 40% to about 60% of the total film thickness. In another embodiment, the core 14 comprises about 50% of the total film thickness.

In illustrative embodiments, the first exterior layer 22 comprises about 5% to about 20% of the total film thickness. In one embodiment, the first exterior layer 22 comprises about 10% to about 15% of the total film thickness.

In another embodiment, the first exterior polymer bed 24 comprises about 5% to about 20% of the total film thickness. In another embodiment, the first exterior polymer bed 24 comprises about 10% to about 15% of the total film thickness.

In one embodiment, the first outer core layer 18 comprises about 5% to about 15% of the total film thickness. In another embodiment the first outer core layer 18 comprises about 10% of the total film thickness.

In one embodiment, the interior polymer bed 16 comprises about 15% to about 45% of the total film thickness. In another embodiment, the interior polymer bed 16 comprises about 20% to about 40% of the total film thickness. In yet another embodiment, the interior polymer bed 16 comprises about 25% to about 35% of the total film thickness. In another embodiment the interior polymer bed 16 comprises about 30% of the total film thickness.

In one embodiment, the second outer core layer 20 comprises about 5% to about 15% of the total film thickness. In another embodiment the second outer core layer 20 comprises about 10% of the total film thickness.

In one embodiment, the second exterior polymer bed 26 comprises about 5% to about 20% of the total film thickness. In another embodiment, the second exterior polymer bed 26 comprises about 10% to about 15% of the total film thickness.

In one embodiment, the second exterior layer 28 comprises about 5% to about 20% of the total film thickness. In one embodiment, the second exterior layer 28 comprises about 10% to about 15% of the total film thickness.

One aspect of the present disclosure is that a manner for combining multiple layers of polyethylene with distinct molecular branching so that a multi-layer heat-shrinkable film can be produced having novel properties was discovered. The effect of branching on the properties of polyethylene depends on the length and the amount of the branches. Short branches mainly influence the mechanical and thermal properties. As the branch length increases, the branches are able to form lamellar structures and the influence on the mechanical and thermal properties is diminished. Accordingly, the extent of short and long-chain branching is important to the properties of a given polymer or polymer blend.

While not being limited to any particular theory, it is believed that the microscopic characteristics of the oriented film substantially contribute to the performance characteristics described herein. The microcrystalline orientation of the substantially linear polyethylene, when used within the scope of the materials and processes described herein, can be described as having a spherulite-like microcrystalline orientation. Structures exhibiting spherulite-like microcrystalline orientations are known to exhibit balanced MD and TD tear resistances.

As used herein, the term microcrystalline orientation refers to regular packing of polymer chains within a polymeric material. Polymers may be characterized as either crystalline or amorphous. Crystalline polymers include microcrystalline regions and amorphous polymers do not. As used herein, crystalline polymers include microcrystalline regions surrounded by amorphous regions. Microcrystalline regions may form in response to the intermolecular and intra-molecular hydrogen bonding and van der Waals attractive forces between the polymer chains. The crystallinity of a polymer refers to the extent of regular packing of molecular chains. Microcystalline orientation refers to the alignment of the microcrystalline regions with respect to each other. Therefore, an oriented polymer is a crystalline polymer that has aligned microcrystalline regions. The orientation exhibited by the microcrystalline regions can be further described. For example, microcrystalline regions can be aligned in row-nucleated microcrystalline orientations with non-twisted lamellae, row-nucleated microcrystalline orientations with twisted lamellae or spherulite-like microcrystalline orientations.

As used herein, a spherulite-like microcrystalline orientation includes spherical semi-crystalline regions characterized by plates of orthorhombic unit cells called crystalline lamellae. These ordered plates are dispersed amongst amorphous regions, wherein even a completely spherulized polymer is not fully crystalline. A spherulite-like microcrystalline orientation will exhibit birefringence due to its high degree of anisotropic order and crystallinity. The process of spherulization starts on a nucleation site and continues to extend radially outwards until a neighboring spherulite is reached. This explains the spherical shape of the spherulite. The presence of spherulites in a polymer changes the properties of the polymer with respect to crystallinity, density, tensile strength and modulus of elasticity. Specifically, each of these properties increases with increasing spherulite content.

The presence of polymers which do not tend to form spherulite-like microcrystalline orientations may inhibit the formation of spherulites or cause an alternative orientation to form. With this interference, the corresponding increase in crystallinity, density, tensile strength and modulus of elasticity may not be observed. In one embodiment, the multi-layer shink film includes at least one layer which strongly exhibits a spherulite-like microcrystalline orientation.

As used herein, row-nucleated microcrystalline orientations include aligned crystalline lamellae, wherein the lamellae are either twisted or non-twisted. The lamellar arrangement is believed to originate from the high-molecular weight fraction of the polymer that orients into fibrils in the film extrusion direction (i.e. MD) during the film extrusion and/or blowing. These fibrils can act as nuclei for further crystallization. Since the lamellae grow perpendicular to the primary nuclei, orientation measurements in row-nucleated microcrystalline orientation blown films may show a preferential orientation in the direction perpendicular to MD, otherwise known as the transverse direction (TD). In illustrative embodiments, the multi-layer shrink film 10 includes at least one layer which strongly exhibits a row-nucleated microcrystalline orientation.

As used herein, a twisted lamellae morphology is when a row-nucleated microcrystalline orientation exhibits intertwined lamellae having an interlocked lamellar assembly instead of well-separated rows (non-twisted). The interlocking lamellae may include a boundary in which lamellae from different rows meet and are strongly connected or overlapped by the twisted growth. This orientation results in a strong increase in the MD tear resistance and MD tensile strength, but also results in a decrease in the TD tear resistance, TD tensile strength, and puncture resistance. In illustrative embodiments, the multi-layer shrink film includes at least one layer which strongly exhibits a twisted lamellae morphology.

Reference is made to Zhang et al. Polymer 45 (2004) 217-229, which is hereby incorporated by reference herein, for disclosure relating to microcrystalline orientation. The microcrystalline orientation of film may be determined by, for example, birefringence or infrared spectroscopy (FTIR).

Multi-layer shrink films in accordance with the present disclosure have many beneficial attributes; for example, the combination of light gauge, high shrink tension, and final tensile properties allow for the efficient containment of goods.

In an evaluation of the properties of a polyolefinic film, tensile testing was performed. Tensile testing involves elongating a specimen and measuring the load carried by the specimen. The dimensions of the specimen and the change in those dimensions upon carrying the load may be used with the load and deflection data to construct a stress-strain curve. Tensile properties can be extracted from the stress-strain curve according to ASTM D 882-00. As used herein, ASTM D 882-00 refers to the standard test method for tensile properties of thin plastic sheeting. Tensile strength is the maximum load divided by the original minimum cross-sectional area of the specimen and differs depending on whether measured in the MD or TD. Percent elongation at break may be calculated by dividing the extension at the moment of rupture of the specimen by the initial gage length of the specimen and multiplying by 100.

One aspect of the present disclosure is that the specific polymeric composition and structure disclosed herein enables the production of films with surprisingly robust tensile properties. One of ordinary skill in the art would not expect that a light-gauge polyethylene heat shrinkable film could be manufactured which provides the tensile properties described herein with the desirable optical properties. In particular, the composition described herein enables the gauge of the film to be significantly reduced while still obtaining tensile properties of significantly thicker films.

In one embodiment, the multi-layer shrink film has a gauge-normalized tensile strength of greater than about 4200 psi in the MD. In another embodiment, the multi-layer shrink film has a gauge-normalized tensile strength of greater than about 4000 psi in the TD. In one embodiment, the multi-layer shrink film has a gauge-normalized tensile strength of greater than about 4800 psi in the MD. In another embodiment, the multi-layer shrink film has a gauge-normalized tensile strength of greater than about 4200 psi in the TD. In yet another embodiment, the multi-layer shrink film has a thickness of about 1.5 mils and a tensile strength of greater than about 6400 psi in the MD. In another embodiment, the multi-layer shrink film has a thickness of about 1.5 mils and a tensile strength of greater than about 6000 psi in the TD. In another embodiment, the multi-layer shrink film has a thickness of about 1.5 mils and a tensile strength of greater than about 7200 psi in the MD. In another embodiment, the multi-layer shrink film has a thickness of about 1.5 mils and a tensile strength of greater than about 6500 psi in the TD.

In illustrative embodiments, the film has an elongation at break of at least about 800 percent in the MD. In one embodiment, the film has an elongation at break of at least about 900 percent in the MD. In illustrative embodiments, the film has an elongation at break of at least about 800 percent in the TD. In one embodiment, the film has an elongation at break of at least about 900 percent in the TD. In another embodiment, the film has an elongation at break of at least about 950 percent in the TD.

In illustrative embodiments, a 1.5 mil gauge film has a secant modulus (1% strain) of at least about 80000 psi in the MD. In one embodiment, a 1.5 mil gauge film has a secant modulus (1% strain) of at least about 90000 psi in the MD. In another embodiment, a 1.5 mil gauge film has a secant modulus (1% strain) of at least about 90000 psi in the TD. In yet another, the film has a secant modulus (1% strain) of at least about 100000 psi in the TD. In one embodiment, the film has a gauge-normalized secant modulus (1% strain) of at least about 59000 psi in the TD. In another embodiment, the film has a gauge-normalized secant modulus (1% strain) of at least about 62000 psi in the TD. In one embodiment, the film has a gauge-normalized secant modulus (1% strain) of at least about 60000 psi in the TD. In another embodiment, the film has a gauge-normalized secant modulus (1% strain) of at least about 65000 psi in the TD.

As used herein, ASTM D 1922-00 refers to the standard test method for propagation tear resistance of plastic film and thin sheeting by pendulum method. The values obtained through the testing methods described by this ASTM standard method are also referred to as Elmendorf values. The Elmendorf values are the force in grams required to propagate tearing across a film or sheeting specimen.

In illustrative embodiments, the multi-layer shrink film has a gauge normalized tear resistance of about 85 g in the MD. In one embodiment, the multi-layer shrink film has a gauge normalized tear resistance of about 100 g in the MD. In another embodiment, the multi-layer shrink film has a thickness of about 1.5 mils and a tear resistance of greater than about 125 g in the MD. In yet another embodiment, the multi-layer shrink film has a thickness of about 1.5 mils and a tear resistance of greater than about 150 g in the MD. In another embodiment, the multi-layer shrink film has a gauge-normalized tear resistance of about 400 g in the TD. In one embodiment, the multi-layer shrink film has a gauge normalized tear resistance of about 500 g in the TD. In another embodiment, the multi-layer shrink film has a thickness of about 1.5 mils and a tear resistance of greater than about 600 g in the TD. In yet another embodiment, the multi-layer shrink film has a thickness of about 1.5 mils and a tear resistance of greater than about 750 g in the TD.

In an evaluation of the properties of a polyolefinic film, the specific light-transmitting and wide-angle-scattering properties of the film may be determined according to ASTM D 1003-00. ASTM D 1003 refers to the standard test method for haze and luminous transmittance of transparent plastics. As used herein, haze is the scattering of light by a specimen responsible for the reduction in contrast of objects viewed through it. Haze is measured as the percentage of transmitted light that is scattered so that its direction deviates more than a specified angle from the direction of the incident beam.

One aspect of the present disclosure is that the multi-layer film is made with a composition that renders a film that does not readily scatter light. The lack of light scattering provides that objects are viewed through the film are perceived with a high degree of clarity. In illustrative embodiments, the film has a haze of less than about 10 percent. In one embodiment, the film has a haze of less than about 8 percent. In another embodiment, the film has a haze of less than about 6 percent.

In an evaluation of the properties of a polyolefinic film, the relative luminous reflectance factor of a specimen in the mirror direction may be determined according to ASTM D 523-89 (re-approved 1999). ASTM D 523 refers to the standard test method for specular gloss. In illustrative embodiments, the specular gloss of at least one side of the film is greater than about 70 percent. In one embodiment, the specular gloss of at least one side of the film is greater than about 75 percent. In one embodiment, the specular gloss of at least one side of the film is greater than about 80 percent. In yet another embodiment, the specular gloss of both sides of the film are substantially equivalent. In another embodiment, the specular gloss of both sides of the film is greater than about 75 percent.

In an evaluation of the properties of a polyolefinic film, the energy that causes the film to fail under specified conditions of impact of a free-falling dart may be determined according to ASTM D 1709-98. ASTM D 1709 refers to the standard test methods for impact resistance of plastic film by the free-falling dart method.

One aspect of the present disclosure is that the polyolefinic composition enables the manufacture of films with improved puncture resistance properties. The puncture resistance, as measured by ASTM D-1709 or other well known puncture resistance tests such as ASTM D-5748, is improved over those compositions known in the art. In one embodiment, the puncture resistance according to the ASTM D-1709 dart drop test is at least about 180 g/mil. In another embodiment, the puncture resistance according to the ASTM D-1709 dart drop test is at least about 190 g/mil.

Table 1 below depicts comparative test data between films in accordance with embodiments of the present disclosure, and films manufactured in accordance with conventional compositions. Comparative Examples A, B, and C are commercially available shrink films. Example 1 and 2 are multi-layer films in accordance with the present disclosure having a first exterior and second exterior layer of metallocene catalyzed linear low density polyethylene having a MI of 0.8 g/10 min and a density of 0.925 g/cm³. The first and second exterior polymer bed is a diversely branched polyethylene having a MI of 0.7 g/10 min and a density of 0.960 g/cm³. The first and second outer core layers are highly branched polyethylene having a MI of 0.6 g/10 min and a density of 0.922 g/cm³. The interior polymer bed is a high density polyethylene having a MI of 0.4 g/10 min and a density of about 0.951 g/cm³.

Example 1 and Example 2 differ in the thickness of each layer compared to the total thickness of the film, described as a percent of the total thickness. For example 1, the first exterior and second exterior layer each comprise 15% of the total film thickness. The first and second exterior polymer bed each comprise 10% of the total film thickness. The first and second outer core layers each comprise 10% of the total film thickness. The interior polymer bed comprises 30% of the total film thickness. For example 2, the first exterior and second exterior layer each comprise 10% of the total film thickness. The first and second exterior polymer bed each comprise 15% of the total film thickness. The first and second outer core layers each comprise 10% of the total film thickness. The interior polymer bed comprises 30% of the total film thickness.

The exemplary films were produced using virgin polymer on a blown-line operating at a blow-up ratio of between 1 and 2.6, at a line speed of 500 ft/min.

TABLE 1

| | Examples | | Comparative Examples | | |
|---|---|---|---|---|---|
| | 1 | 2 | A | B | C |
| Gauge (mil) | 1.50 | 1.50 | 1.50 | 1.50 | 1.50 |
| Tensile-MD (psi) | 7238 | 6406 | 4100 | 5544 | 6200 |
| Tensile-TD (psi) | 6524 | 5989 | 3462 | 5389 | 5780 |
| Elongation-MD (%) | 916 | 845 | 460 | 980 | 945 |
| Elongation-TD (%) | 946 | 933 | 670 | 1100 | 1090 |
| Secant 1%-MD (units) | 93756 | 89205 | 45689 | 41054 | 62100 |
| Secant 1%-TD (units) | 102190 | 91115 | 51726 | 44624 | 66200 |
| Elmendorf-MD (g) | 147 | 126 | 130 | 180 | 170 |
| Elmendorf-TD (g) | 621 | 781 | 850 | 740 | 850 |
| Gloss-I (%) | 80.0 | 76.0 | 74.0 | 75.0 | 73.0 |
| Gloss-II (%) | 81.0 | 75.0 | 73.0 | 73.0 | 72.0 |
| Haze (%) | 8.1 | 5.4 | 14.0 | 10.0 | 6.4 |
| Dart Drop (g) | 290 | 274 | 210 | 180 | 150 |
| Free Shrink | | | | | |
| 140 degrees C.-MD (%) | 76 | 76 | 73 | 70 | 74 |
| 140 degrees C.-TD (%) | 16 | 16 | 8 | 8 | 12 |

In one aspect, the disclosed composition has unexpected shrink properties concurrent with high clarity and low gauge. In particular, the composition described herein enables the manufacture of low-gauge high clarity films with properties that heretofore were not possible. Furthermore, a surprising combination of resins was used herein to take advantage of the unique properties of the different molecular structures in the particular combinations as described herein. The surprising shrink properties are particularly noticeable in that the films of the present disclosure exhibit tensile strength and puncture resistance exceeding those of the comparative examples while exhibiting excellent clarity.

While specific polymer compositions are referred to herein, one of ordinary skill in the art will appreciate that polymers or polymer blends with substantially equivalent physical properties may be substituted; yet remain within the scope and spirit of the present disclosure. In particular, those polymers having substantially equivalent melt indexes (MI) and flow ratios (FR) may be suitable. One of ordinary skill in the art will appreciate that MI (units herein of g/10 min) is an indication of molecular weight, wherein higher MI values typically correspond to low molecular weights. At the same time, MI is a measure of a melted polymer's ability to flow under pressure. FR is used as an indication of the manner in which rheological behavior is influenced by the MWD of the material. While not being limited to theory, MI and FR are indirect predictors of the microcrystalline orientation which may be formed in the polymer.

All patents, applications and publications referred to herein are incorporated by reference in their entirety.

1. A multi-layer heat-shrinkable polyolefinic film comprising
a first exterior sheet including a first exterior layer and a first exterior polymer bed,
a core including a first outer core layer, an interior polymer bed, and a second outer core layer,
a second exterior sheet including a second exterior polymer bed and a second exterior layer, wherein
the film is configured to provide, in series, the first exterior layer, the first exterior polymer bed, the first outer core layer, the interior polymer bed, the second outer core layer, the second exterior polymer bed, and the second exterior layer,
the first exterior layer and the second exterior layer comprise resin having a first MI of about 0.25 to about 1.0 g/10 min and a first density of about 0.915 to about 0.940 g/cm³,
the first exterior polymer bed and the second exterior polymer bed comprise resin having a second MI of about 0.15 to about 1.0 g/10 min and a second density of about 0.939 to about 0.960 g/cm³,
the first outer core layer and the second outer core layer comprise resin having a third MI of about 0.3 to about 1.0 g/10 min and a third density of about 0.915 to about 0.930 g/cm³,
the interior polymer bed comprises resin having a fourth MI of about 0.17 to about 0.6 g/10 min and a fourth density of about 0.935 to about 0.960 g/cm³, and
the film has a MD gauge normalized secant modulus (1% strain) of at least about 60000 psi.

2. The film of claim 1, wherein the film has a thickness of between about 0.5 to about 3 mils and exhibits a MD shrink of about 60% to about 90% and a TD shrink of about 5% to about 25% when subjected to a temperature of about 140° C. for about 10 to about 30 seconds.

3. The film of claim 2, wherein each of the first exterior polymer bed and the second exterior polymer bed comprises a diversely branched polyethylene.

4. The film of claim 3, wherein each of the first outer core layer and the second outer core layer comprises an amorphous polyethylene having substantial short- and long-chain branching or a blend thereof with a first substantially short-chain branched linear polyethylene.

5. The film of claim 4, wherein each of the first exterior layer and the second exterior layer comprises a second substantially short-chain branched linear polyethylene.

6. The film of claim 5, wherein the first substantially short-chain branched linear polyethylene is present in each of the first outer core layer and the second outer core layer in an amount between about 5% and about 50% by weight.

7. The film of claim 5, wherein the second substantially short-chain branched linear polyethylene is present in each of the first outer core layer and the second outer core layer in an amount between about 10% and about 30% by weight.

8. The film of claim 2, wherein each of the first exterior polymer bed and the second exterior polymer bed comprises a blend of about 70% to about 90% by weight an amorphous polyethylene having substantial short- and long-chain branching and about 10% to about 30% by weight a substantially short-chain branched linear polyethylene.

9. The film of claim 8, wherein each of the first outer core layer and the second outer core layer comprises a diversely branched polyethylene

10. The film of claim 8, wherein the substantially short-chain branched linear polyethylene comprises about 2% to about 10% 1-octene by weight.

11. The film of claim 2, wherein the film has a haze of less than about 10% as measured according to ASTM D 1003-00 and a specular gloss of at least about 80% as measured according to ASTM D 523.

12. The film of claim 11, wherein the film has a MD and TD gauge normalized tensile strength of at least about 4000 psi.

13. A light gauge multi-layer polyethylene film comprising at least seven layers having a MD secant modulus (1% strain) of at least about 85000 psi, a TD secant modulus (1% strain) of at least about 90000 psi, a haze of less than about 10% as measured according to ASTM D 1003-00, and a specular gloss of at least about 80% as measured according to ASTM D 523.

14. The light gauge multi-layer polyethylene film of claim 13, wherein the light gauge multi-layer polyethylene film has a thickness of between about 0.5 to about 3 mils and exhibits a MD shrink of about 60% to about 90% and a TD shrink of about 5% to about 25% when subjected to a temperature of about 140° C. for about 10 to about 30 seconds.

15. The light gauge multi-layer polyethylene film of claim 13, wherein the light gauge multi-layer polyethylene film comprises
a first exterior sheet comprising a first exterior layer and a first exterior polymer bed,
a second exterior sheet comprising a second exterior layer and a second exterior polymer bed, and
a core interposed between the first exterior sheet and the second exterior sheet, the core comprising an interior polymer bed interposed between a first outer core layer and a second outer core layer, wherein
the first exterior layer-comprises a first polyethylene having a first MI of about 0.25 to about 1.0 g/10 min and a first density of about 0.915 to about 0.940 g/cm³,
the first exterior polymer bed is interposed between the first exterior layer and the core,
the first exterior polymer bed comprises a second polyethylene having a second MI of about 0.15 to about 1.0 g/10 min and a second density of about 0.939 to about 0.960 g/cm³,
the first outer core layer is interposed between the first exterior sheet and the interior polymer bed,
the first outer core layer comprises a third polyethylene having a third MI of about 0.3 to about 1.0 g/10 min and a third density of about 0.915 to about 0.930 g/cm³,
the interior polymer bed is interposed between the first outer core layer and the second outer core layer, and
the interior polymer bed comprises a fourth polyethylene having a fourth MI of about 0.17 to about 0.6 g/10 min and a fourth density of about 0.935 to about 0.960 g/cm³.

16. The light gauge multi-layer polyethylene film of claim 15, wherein
the second exterior layer comprises the first polyethylene,
the second exterior polymer bed comprises the second polyethylene, and
the second outer core layer comprises the third polyethylene.

17. A heat-shrinkable film comprising seven layers, wherein the film has a thickness of between about 0.5 to about 3 mils and exhibits a MD shrink of about 60% to about 90% and a TD shrink of about 5% to about 25% when subjected to a temperature of about 140° C. for about 10 to about 30 seconds.

18. The heat-shrinkable film of claim 17, wherein each of the seven layers consists essentially of polyethylene.

19. The heat-shrinkable film of claim 17, wherein the film is compositionally symmetrical about an inner core layer.

20. The heat-shrinkable film of claim 17, wherein each of at least two of the seven layers comprises a diversely branched polyethylene.
